(19) United States
(12) Patent Application Publication
(10) Pub. No.: US 2013/0106563 A1
(43) Pub. Date: May 2, 2013

(54) TEMPERATURE SWITCH

(71) Applicant: Yu-Kang Yang, Tainan City (TW)

(72) Inventor: Yu-Kang Yang, Tainan City (TW)

(73) Assignee: Yu-Kang Yang, Tainan City (TW)

(21) Appl. No.: 13/406,946

(22) Filed: Feb. 28, 2012

(30) Foreign Application Priority Data
Oct. 28, 2011 (TW) 100139374

(51) Int. Cl. H01H 89/00

(52) U.S. Cl. 337/143

(57) ABSTRACT

A temperature switch is electrically connected with a first wire and a second wire, and includes a base, a conducting mechanism including a first conducting piece electrically connected to the first wire, a second conducting piece electrically connected to the second wire, a fixed conducting component electrically connected to the first conducting piece and having a fixed contact, a conducting resilient piece having a movable contact contactable with the fixed contact, and at least one fuse electrically interconnecting the conducting resilient piece and the second conducting piece, and a temperature control mechanism for controlling contact between the movable contact and the fixed contact according to a sensed temperature.

### BACKGROUND OF THE INVENTION

1. Field of the Invention

The invention relates to a switch, and more particularly to a temperature switch that controls power supply from a power source to a heating device for protecting the heating device when an abnormal temperature condition exists.

2. Description of the Related Art

A common electrical appliance configured for heating, such as a water dispenser, a coffeemaker, an electrical iron, a hairdryer, etc., employs a temperature switch to control a heater thereof to keep a desired temperature and to prevent dangers resulting from continuous heating at an abnormal temperature. In order to ensure safety of the electrical appliance, a fuse is usually disposed therein to avoid damage resulting from power supply abnormality. As such, the temperature switch and the fuse are usually disposed in common electrical appliances to control temperature and ensure safety.

However, when the temperature switch and the fuse are incorporated into an electrical appliance, additional wirings are required, thus resulting in more assembly steps and higher costs. Besides, electrical appliance designs have a trend toward miniaturization. If all of the temperature switch, the fuse, and the additional wirings are configured into the electrical appliance, a relatively large space must be provided therefor, thereby resulting in limitation of product design.

### SUMMARY OF THE INVENTION

Therefore, an object of the present invention is to provide a safety temperature switch that is easy to assemble, that has a lower cost, and that can control temperature effectively.

According to the present invention, a temperature switch is adapted to be electrically connected with a first wire and a second wire. The temperature switch comprises:

abase including a base body and a cap body connected to the base body to form an accommodating chamber therebetween;

a conducting mechanism including a first conducting piece adapted to be electrically connected to the first wire, a second conducting piece adapted to be electrically connected to the second wire, a fixed conducting component electrically connected to the first conducting piece and having a fixed contact disposed in the accommodating chamber, a conducting resilient piece having a movable contact contactable with the fixed contact, the movable contact being biased to separate from the fixed contact, and at least one fuse electrically interconnecting the conducting resilient piece and the second conducting piece; and

a temperature control mechanism configured to control contact between the movable contact of the conducting resilient piece and the fixed contact of the fixed conducting component with a sensed temperature.

### BRIEF DESCRIPTION OF THE DRAWINGS

Other features and advantages of the present invention will become apparent in the following detailed description of the preferred embodiment with reference to the accompanying drawings, of which:

FIG. 1 is an exploded perspective view illustrating a preferred embodiment of a temperature switch according to the present invention;

FIG. 2 is a sectional view of the preferred embodiment to illustrate the temperature switch in a conducting condition;

FIG. 3 is a sectional view similar to FIG. 2 to illustrate the temperature switch in a non-conducting condition;

FIG. 4 is a sectional view similar to FIG. 2 to illustrate the temperature switch in a first safety condition; and

FIG. 5 is a sectional view similar to FIG. 2 to illustrate the temperature switch in a second safety condition.

### DETAILED DESCRIPTION OF THE PREFERRED EMBODIMENT

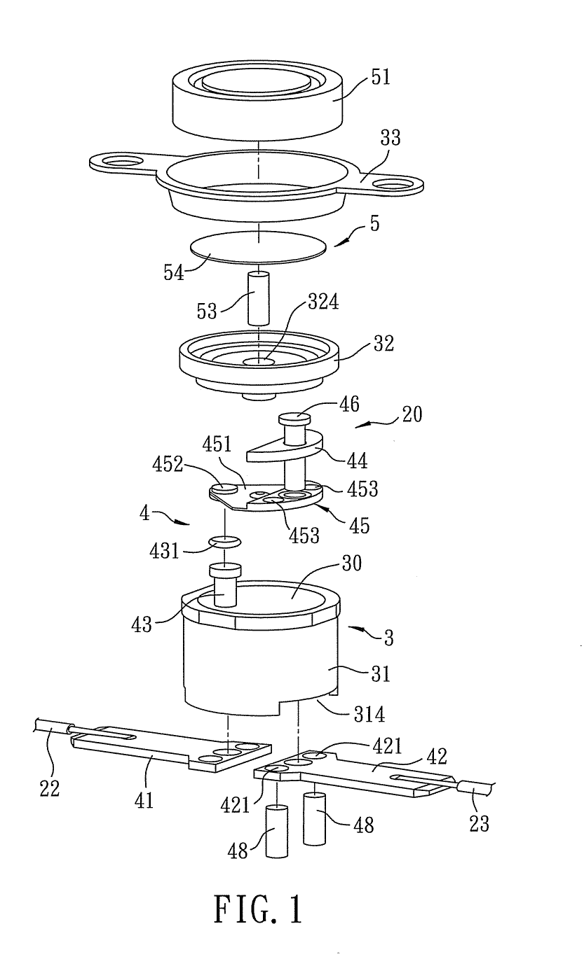

Referring to FIG. 1 to FIG. 3, the preferred embodiment of the temperature switch 20 according to the present invention is to be installed on an electrical appliance, and is in contact with a heating component 21. The temperature switch 20 is adapted to be electrically connected with a first wire 22 and a second wire 23, and comprises a base 3, a conducting mechanism 4 disposed in the base 3, and a temperature control mechanism 5 disposed on the base 3.

In this embodiment, the base 3 includes a base body 31 made of an insulating and high temperature resistant material, such as a ceramic material or a plastic material, a cap body 32 connected to the base body 31 to form an accommodating chamber 30 therebetween, and a mounting bracket 33 sleeved on the base body 31. The base body 31 has a base wall 311, and a surrounding wall 312 extending upwardly from a periphery of the base wall 311 toward the cap body 32. The base wall 311 has a platform 313 extending into the accommodating chamber 30, and two conducting-piece mounting grooves 314 formed in a bottom surface of the base wall 311. The cap body 32 has an annular holding wall 321 abutting against a top end of the surrounding wall 312 of the base body 31, an extending wall 322 extending inwardly from the annular holding wall 321 toward the center of the accommodating chamber 30, and an annular limiting wall 323 extending downwardly from the extending wall 322 toward the bottom of the base body 31. A limiting hole 324 is formed through the limiting wall 323 and the extending wall 322.

The conducting mechanism 4 includes: a first conducting piece 41 adapted to be electrically connected to the first wire 22 and extending into one of the conducting-piece mounting grooves 314; a second conducting piece 42 adapted to be electrically connected to the second wire 23, extending into the other one of the conducting-piece mounting grooves 314, and having two first coupling holes 421; a fixed conducting component 43 configured as a vertical rod, extending through the base wall 311 of the base 31, electrically connected to the first conducting piece 41, and having a fixed contact 431 disposed in the accommodating chamber 30; a conducting resilient piece 45 disposed on the platform 313 of the base 3 such that the limiting hole 324 is aligned with an intermediate portion thereof, and having a free end 451, a movable contact 452 disposed on the free end 451 and contactable with the fixed contact 431, the movable contact 452 being biased to separate from the fixed contact 431, and two second coupling holes 453 aligned with the two first coupling holes 421, respectively; a gasket 44 disposed on the conducting resilient piece 45; a coupling component 46 that is made of an insulating material and passes through the gasket 44 and the conducting resilient piece 45 to clamp the conducting resilient piece 45 between the gasket 44 and the base body 31; and two fuses 48 electrically interconnecting the conducting resilient piece 45 and the second conducting piece 42 and extending through the first coupling holes 421 and the second coupling holes 453.

The temperature control mechanism 5 includes a temperature-sensing cap 51 made of a heat-conductive material and connected to the cap body 32 of the base 3 to form a deformation space 52 between the cap body and the temperature-sensing cap 51, and a temperature-sensing control plate 54 that is disposed in the deformation space 52, and that has a deforming part 541 disposed at a central portion thereof and deformable due to temperature change in such a manner to move between a proximate position and a distal position farther away from the conducting resilient piece 45 than the proximate position, and a heat-conductive part 542 disposed along a periphery thereof and deformable to contact the temperature-sensing cap 51. The temperature control mechanism 5 further includes a linking rod 53 made of a heat-insulating ceramic material and disposed movably in the limiting hole 324. The linking rod 53 is aligned with the deforming part 541, is disposed between and in contact with the temperature-sensing control plate 54 and the conducting resilient piece 45, and is movable toward and away from the temperature-sensing control plate 54 and the conducting resilient piece 45 along a longitudinal direction of the limiting hole 324 such that, when the deforming part 541 of the temperature-sensing control plate 54 is at the proximate position, the movable contact 452 is in contact with the fixed contact 431, and when the deforming part 541 of the temperature-sensing control plate 54 is at the distal position, the movable contact 452 is spaced apart from the fixed contact 431.

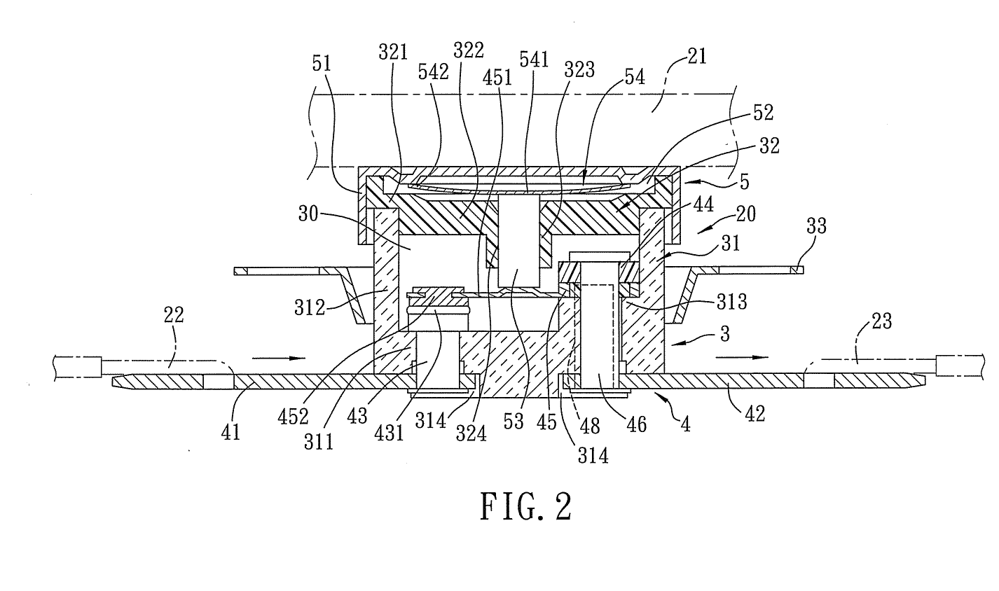

In this embodiment, when the temperature switch 20 is in a conducting condition as shown in FIG. 2, the deforming part 541 of the temperature-sensing control plate 54 is at the proximate position, and the linking rod 53 is pressed against the conducting resilient piece 45, so that the movable contact 452 on the free end 451 of the conducting resilient piece 45 is in contact with the fixed contact 431, thereby resulting in a closed circuit through the first wire 22, the first conducting piece 41, the fixed conducting component 43, the conducting resilient piece 45, the fuses 48, the second conducting piece 42 and the second wire 23.

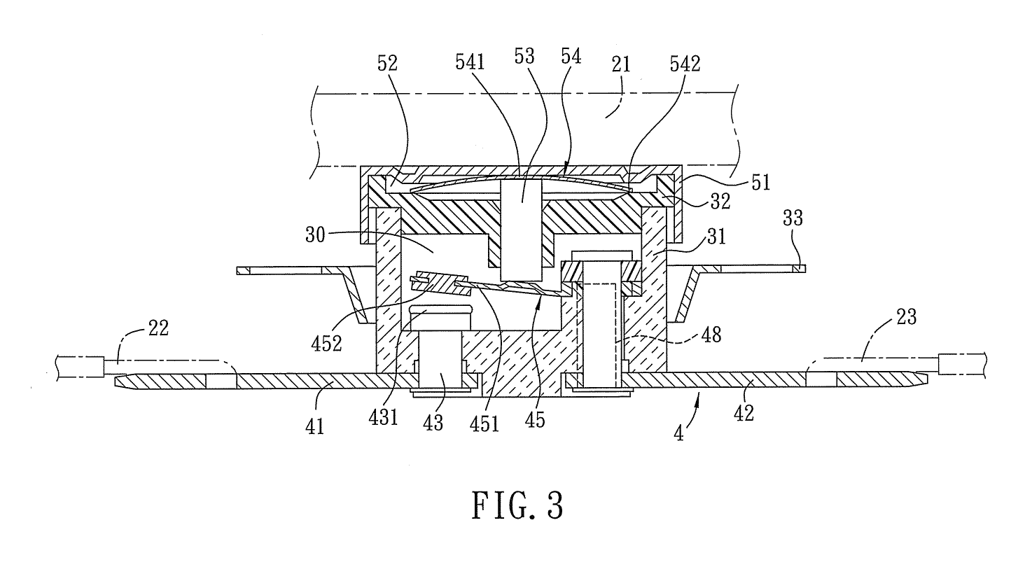

When the heating component 21 is heated to reach a pre-determined first temperature, the deforming part 541 of the temperature-sensing control plate 54 moves from the proximate position to the distal position, so that the linking rod 53 is no linger pressed against the conducting resilient piece 45, thus allowing the movable contact 452 on the free end 451 of the conducting resilient piece 45 to be biased to separate from the fixed contact 431 to interrupt electrical connection between the first and second wires 22, 23. In other words, the temperature switch 20 is converted from a conducting condition as shown in FIG. 2 to a non-conducting condition as shown in FIG. 3. When temperature of the heating component 21 drops to a predetermined second temperature, the deforming part 541 of the temperature-sensing control plate 54 moves from the distal position as shown in FIG. 3 back to the proximate position as shown in FIG. 2, such that the heater of the electrical appliance will perform a heating operation again.

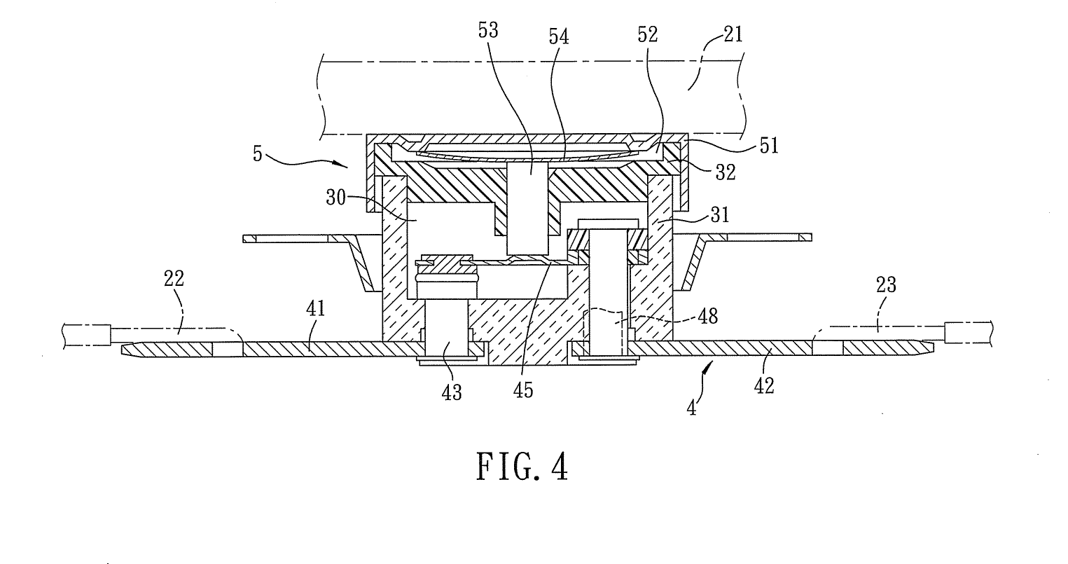

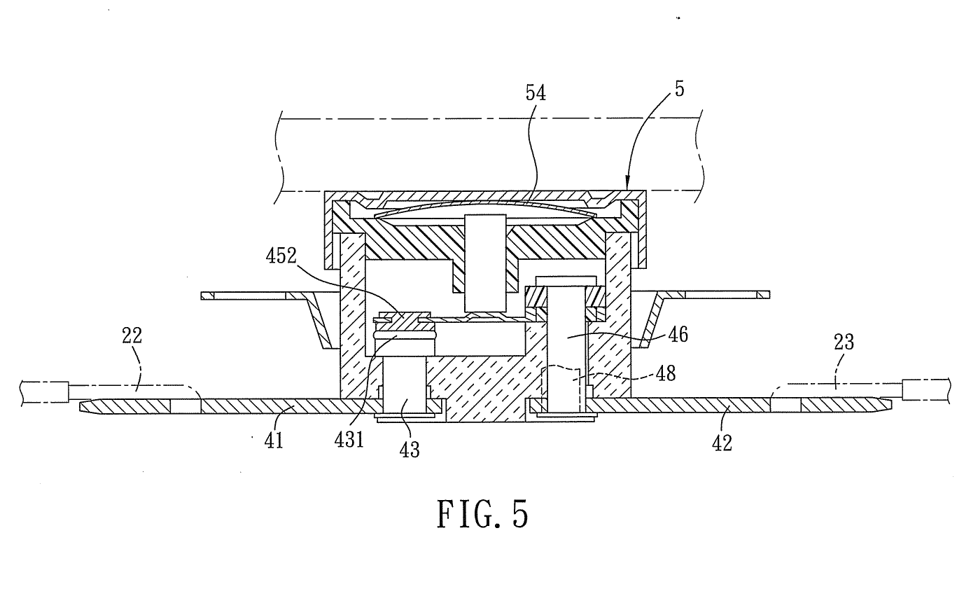

Referring to FIG. 2, FIG. 4, and FIG. 5, when the temperature switch 20 is in the conducting condition as shown in FIG. 2 and the temperature of the heating component 21 is higher than the predetermined first temperature, under the normal operation, the temperature-sensing control plate 54 deforms to separate the movable contact 452 and the fixed contact 431 from each other (as shown in FIG. 3). However, if the temperature-sensing control plate 54 is disabled from deformation, the heater of the electrical appliance will keep on heating to thereby result in an increase in the temperature of the temperature-sensing cap 51 and the environmental temperature thereof. When the temperature of the heating component 21 rises to a third temperature, the fuses 48 are blown to form an open circuit, so as to change the temperature switch 20 to a first safety condition as shown in FIG. 4.

Abnormal condition of the conducting mechanism 4 may also exist, e.g., when the temperature rises to the predetermined first temperature, the deforming part 541 of the temperature-sensing control plate 54 moves to the distal position, if the movable contact 452 and the fixed contact 431 are still abnormally in contact with each other to form a closed circuit between the first wire 22 and the second wire 23, the heater of the electrical appliance keeps on heating to thereby result in an increase in the temperature of the temperature-sensing cap 51 and the environmental temperature thereof. When the temperature of the heating component 21 rises to the third temperature, the fuses 48 are blown to form an open circuit, so as to change the temperature switch 20 to a second safety condition as shown in FIG. 5. That is, when any part of the conducting mechanism 4 or the temperature control mechanism 5 of the temperature switch 20 is abnormal, the fuses 48 serve as a second safety mechanism to cut off the power supply.

To sum up, by integrating the fuses 48 of the conducting mechanism 4 and the temperature control mechanism 5 on the base 3, the temperature switch 20 according to the present invention serves as a double safety control device with the same size as a conventional temperature switch. For this reason, when the temperature switch 20 is installed on the electrical appliance, neither changing arrangement of other components nor providing additional wirings for connecting with other safety objects are needed. Besides, the fuses 48 can be disposed fixedly in the base 3 according to the present invention, so as to enhance stability of the fuses 48 under the abnormal environmental temperature.

While the present invention has been described in connection with what is considered the most practical and preferred embodiment, it is understood that this invention is not limited to the disclosed embodiment but is intended to cover various arrangements included within the spirit and scope of the broadest interpretation so as to encompass all such modifications and equivalent arrangements.

What is claimed is:

1. A temperature switch adapted to be electrically connected with a first wire and a second wire, said temperature switch comprising:
abase including a base body and a cap body connected to said base body to form an accommodating chamber therebetween;
a conducting mechanism including a first conducting piece adapted to be electrically connected to said first wire, a second conducting piece adapted to be electrically connected to said second wire, a fixed conducting component electrically connected to said first conducting piece and having a fixed contact disposed in said accommodating chamber, a conducting resilient piece having a movable contact contactable with said fixed contact, said movable contact being biased to separate from said fixed contact, and at least one fuse electrically interconnecting said conducting resilient piece and said second conducting piece; and
a temperature control mechanism configured to control contact between said movable contact of said conducting resilient piece and said fixed contact of said fixed conducting component with a sensed temperature.

2. The temperature switch as claimed in claim 1, wherein said second conducting piece further has at least one first coupling hole, said conducting resilient piece having at least one second coupling hole aligned with said first coupling hole, said fuse extending through said first coupling hole and said second coupling hole.

3. The temperature switch as claimed in claim 2, wherein said temperature control mechanism includes a temperature-sensing control plate having a deforming part deformable due to temperature change in such a manner to move between a proximate position and a distal position farther away from said conducting resilient piece than the proximate position, and a linking rod disposed between and in contact with said deforming part of said temperature-sensing control plate and said conducting resilient piece such that, when said deforming part of said temperature-sensing control plate is at the proximate position, said movable contact is in contact with said fixed contact, and when said deforming part of said temperature-sensing control plate is at the distal position, said movable contact is spaced apart from said fixed contact.

4. The temperature switch as claimed in claim 3, wherein said conducting resilient piece further has a free end where said movable contact is disposed, said cap body of said base having a limiting hole aligned with an intermediate portion of said conducting resilient piece and permitting extension of said linking rod of said temperature control mechanism, so as to limit movement of said linking rod toward and away from said temperature-sensing control plate and said conducting resilient piece along a longitudinal direction of said limiting hole, said temperature control mechanism further including a temperature-sensing cap connected to said cap body to form a deformation space between said cap body and said temperature-sensing cap for receiving said temperature-sensing control plate.

5. The temperature switch as claimed in claim 4, wherein said deforming part is disposed at a central portion of said temperature-sensing control plate, and said temperature-sensing control plate further has a heat-conductive part disposed along a periphery thereof, which is deformable to contact said temperature sensing cap.

6. The temperature switch as claimed in claim 1, wherein said conducting mechanism further includes a gasket abutting against said conducting resilient piece, and a coupling component passing through said gasket and said conducting resilient piece to clamp said conducting resilient piece between said gasket and said base body.
